(19) United States
(12) Patent Application Publication
(10) Pub. No.: US 2012/0084386 A1
(43) Pub. Date: Apr. 5, 2012

(54) SYSTEM AND METHOD FOR SHARING NETWORK STORAGE AND COMPUTING RESOURCE

(76) Inventor: KUAN-CHANG FU, TAOYUAN COUNTY (TW)

(21) Appl. No.: 13/235,328

(22) Filed: Sep. 16, 2011

(30) Foreign Application Priority Data
Oct. 1, 2010 (TW) 99133514

(51) Int. Cl. G06F 15/167; G06F 15/173

(52) U.S. Cl. 709/214; 709/226

(57) ABSTRACT

Under a community environment, a system and a method for sharing network storage and computing resource are disclosed. In particular, the method employs some available-to-shared computer resources of a group member to share with others. The member may decide a specific storage space to be shared, or the unused computing resource of its processor for others. According to one of the embodiments, the method for storing includes a step of synchronizing the group information and a resource allocation table with records of storage nodes after logging on a community server. Next, a distributed storing process is performed to distribute an object across several nodes within a community group. The method for computing includes a step of generating a computing request from a user-end system. A distributed computation is accomplished since some computing nodes within a community group are allocated for the request according to a computing resource allocation table.

### BACKGROUND OF THE INVENTION

1. Field of the Invention

The instant disclosure relates to a system and a method for sharing network storage and computer resource, more particularly, the system provides a network resource sharing scheme to share a portion of storage and computing resource to the users in a virtual community network.

2. Description of Related Art

The conventional development of network technologies focuses on the information distribution over the network. The network structure is generally based on client-server architecture. For instance, the well-known network neighborhood developed by Microsoft® Corporation is based on the client-server architecture and used for sharing the network resource within a local area network. Other conventional network services, such as electronic mail, file transfer protocol (FTP), and hypertext transfer protocol (HTTP), are also based on the client-server architecture. Further, a service providing network storage for user's access is also based on this framework.

Regarding the foregoing types of network services, the accompanied problems trouble the providers and users due to the more and more requirements of network bandwidth usage and/or storage. The modern service, for example the photo-sharing website, consumes much more network space to store the photos. The website operator (server) should prepare sufficient bandwidth and storage to meet the minimum requirements. The service further requires the computing resources which are used to process the network signaling and user authentications.

In the conventional technology of applying the network computing resources, a grid computing technology is one of the applications. Grid computing may adequately use the much more available-to-shared computing resources over a network. The computing resources generally are the unused central processor cycles and disk space of a desktop computer. A resource management mechanism is indispensably introduced to establishing a virtual computing cluster with the computing resources distributed over the network. This grid computing technology is one of the solutions to fulfill the great computing needs.

The described grid computing implements a kind of distributed computation over the network since it integrates the multiple processors or multiple computer systems over a local area network.

Thus the detailed description directed to the invention is disclosed to provide a solution to the problem.

### SUMMARY OF THE INVENTION

The instant disclosure relates to a system and method for sharing network storage and computing resource under a community framework. The available-to-shared resources of the users in a network community are particularly introduced into the system. The available-to-shared resources, such as the storage spaces authorized by users, or computing resources of central processor in users' computers, are incorporated.

The system and method for sharing network storage and computing resource are applied to a virtual network community where multiple users register at. The virtual network community may not be within a general open network, on the contrary, the users therefor should be identified for accessing the resources. One or more groups specified for the multiple registered users can be therefore established. The users may communicate with each other through the activities built by community mechanism. For example, the users may subscribe each other's messages, friend's relationship, and conduct matching for group members based some items, such as interest surveys and automatically made by the system. The group members may mutually share files.

It is particular that the system may ask the users in the community to share their available-to-shared storage spaces and computing resources of CPUs. Those resources are mutually shared through the community or some inside groups. The shared storage spaces may be provided for storing the files, and the computing resources are for any distributed computing request. This sharing mechanism of the invention implements the distributed storage and computing, and as well saves the computer resources and allows users to extend their storage spaces. Further, the network bandwidth may be adequately shared with others.

According to one of the embodiments, the network storing method for the virtual network community having a plurality registered users includes a community server linked with the user-end systems. Each user-end system is firstly synchronized with the information of groups that it joins, and a resource allocation table recording the information of storage nodes. The available storage nodes within the community can be acquired from the resource allocation table for storage space. After that, it is determined that whether or not the capacity of the total storage space can store an object-to-be-stored. If the capacity is sufficient, a distributed storing process is then performed.

The distributed storing process firstly divides the object into multiple block files according to the storage space shared from the available storage nodes. Then the multiple divided block files are transferred to the storage nodes. The resource allocation table for storage space is then updated when the storing process is verified to be completed.

The method for sharing the computing resource includes generating a computing request from a user-end system; receiving a resource allocation table for computing; and the group relationship for user-end system and the rate of usefulness of the available computing nodes, and their available computing resources can be acknowledged. A computing allocation configured for each computing node is then created.

The each requester (user-end system) may transfer the distributed computing request to every computing node. While the computation is completed, the user-end system receives the result of computation from each computing node and compiles to have a final result.

### BRIEF DESCRIPTION OF THE DRAWINGS

FIG. 1A and FIG. 1B show a schematic diagram of a basic group of community;

FIG. 2A, FIG. 2B, and FIG. 2C is a schematic diagram illustrating the resource shared for each user in a community;

FIG. 3 shows a schematic diagram of a system for network storage and computing resource sharing in accordance with the present invention;

FIG. 4 is a schematic diagram illustrating an object divided for storage in accordance with the present invention;

FIG. 5 illustrates a flow chart of computing resource sharing in accordance with the present invention;

FIG. 6 is a flow chart illustrating distributed storage in accordance with invention;

FIG. 7 is a flow chart illustrating a method for retrieving distributed file in accordance with the present invention;

FIG. 8 is a flow chart of processing a situation of the group members being varied according to the present invention.

### DETAILED DESCRIPTION OF THE PREFERRED EMBODIMENTS

The present invention is now described fully hereinafter with reference to the accompanying drawings showing embodiments of the present invention. The present invention, however, may be embodied in many different forms and should not be construed as limited to embodiments set forth herein. Appropriately, these embodiments are provided so that this disclosure will be thorough and complete, and will fully convey the scope of the present invention.

Rather than the strategy of private storage space of each user-end system within the current virtual network community, the framework running distributed storing process in accordance with present invention is disclosed. The framework defines group serving a shared storage space. The group members may designate a storage space to be shared with every member. This shared storage space may allow other group members to conduct an offsite backup for private data. Any private file is divided into multiple blocks before the file is sent out. The blocks are encoded and sent to the shared storage space. In one embodiment, the block indexes for the file and the related encrypting key are stored in a system which is deemed as an indexing server. However, the member does not recognize the data that is stored by the other members.

Disclosed is a system constituted over a network community for sharing network storage and computing resource, and a method for implementing the sharing. In one of the embodiments, the system implementing the network storage and computing resource sharing is primarily applied to a virtual network community. The plurality of users are particularly registered in a community server for joining the network community. The community server may provide webpage or any proprietary interface program for users to login. When a registered user enters this virtual community through a login process within community server, the system may automatically establish a correlation with other users according to the information that the user provides during registering process. Further, the user may also actively or passively establish the correlation with others based on interests, group relationship. For example, the users may accordingly add friends with each other.

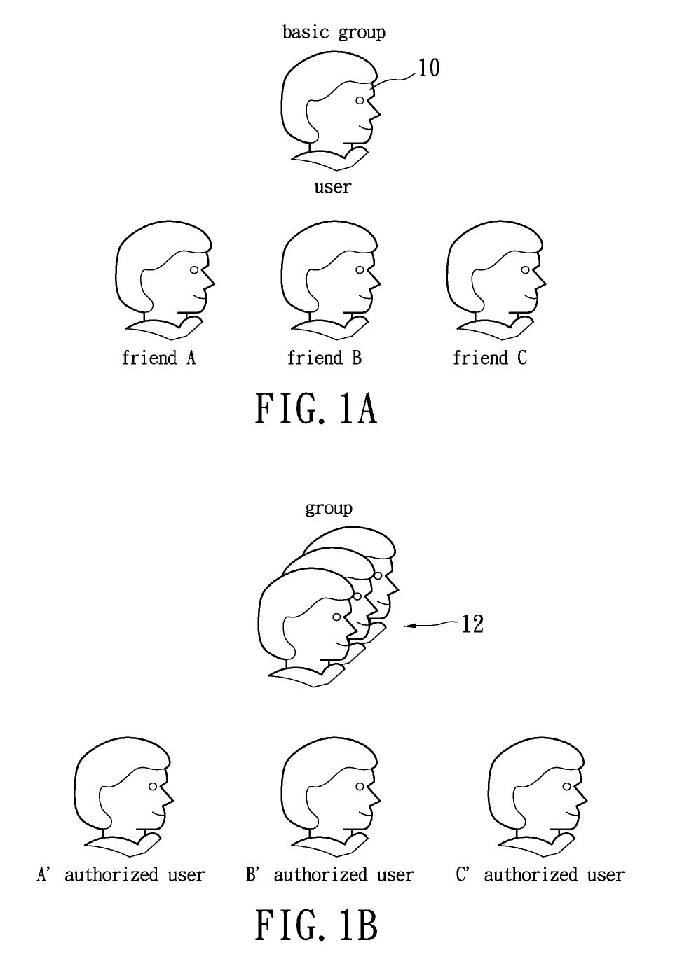

The mentioned “community” is general term used for a virtual network relationship. The members logging in a specific server based on they may have common characteristics or some same specific purposes form this virtual network community. Within a single community, the members may also be collected to be some different groups based on different objectives or their interests. The members within a community may define their own friend circles by means of a community server program prepared by a community server. The system for implementing the sharing of network storage and computing resource provides a server which is able to synchronously record the user and his friends who have the correlation. In one further exemplary example, if the user end installs the software prepared by the community, the software may synchronously record the friends designated by the user. Then a group including the users and their designated friends are established. The schematic diagram describing the groups in a community is shown in FIG. 1A.

Reference is made to FIG. 1A. A user 10 may add the friends A, B, C into his own circle so as to form a basic group. FIG. 1B shows another type which strictly defines a group rather than the previous type allows the user to designate his friends. In the present embodiment, the user may applies for establishing a group, and acts as an administrator for this group. The administrator is able to invite (authorize) other users joining this group. The authorized users may instantly be one of the members of this group. For example, the group 12 shown in the diagram and other authorized users A′, B′, C′ are within one group.

Generally, one user may belong to one or more various groups. Relative to all the other users' data in the same group, every user shall have his private object(s) and public object(s) divisionally. The objects are exemplarily the files including text, image, and video. Furthermore, the message delivered among the users can also be regarded as the objects. When the group member creates an object, he can decide to keep the object to be private, or to be public sharing with other group members.

The group may be formed by collecting a user and his friends, or by grouping the administrator and his authorized users. One of the objectives of the system for sharing network storage and computing resource in accordance with the present invention is to provide the method for distributed storing the objects and computing based on the group relationship.

In particular, the system and method for implementing sharing the network storage and computing resource employs the available-to-shared resources of the computer systems within the above-described group. The available-to-shared resources may be determined by the user, such as the storage space, or computing resource of computer system's central processor. In one preferred embodiment, the shared resources may not be open to all the users, but to the authorized users who are permitted to use the resources in the community, exemplarily the group(s) established by the plurality of users.

In accordance with one embodiment, the disclosed technology is preferably used for performing a distributed storing process and distributed computation, and the aspect is applied to the mentioned network community. The community administrator may demand the registered users to share part of their available-to-shared storage spaces and the computing resources of central processors, no matter whether the sharing part is mandatory or non-mandatory. Those shared resources may be distributed to other users through the community or its group(s). The available-to-shared storage spaces and computing resources are provided for users to store and conduct specific computing request. In addition to achieving the aspect of file sharing, the bandwidth consumption can be reduced, and the storage space can be extended. Further, the computing resource through the system can be effectively shared with each other for enhancing the capability of personal computation.

Under this sharing mechanism, the group having multiple users who may agree to share equal or unequal available-to-shared storage space with each other is established based on users' agreement. Since the personal provided space and the available useful storage provided group the users agree to join are acknowledged, the private data of user of the group may be divided into a plurality of small data blocks. Those small data blocks are encoded and stored into the storage volumes shared by other group members. It is noted that the available space for each user may be smaller than the contribution from each user since the one data file may be stored in multiple volumes shared by multiple users in consideration for availability and security. However, the practical distribution of the storage volumes is modifiable due to the security configuration made by each group.

### First Embodiment

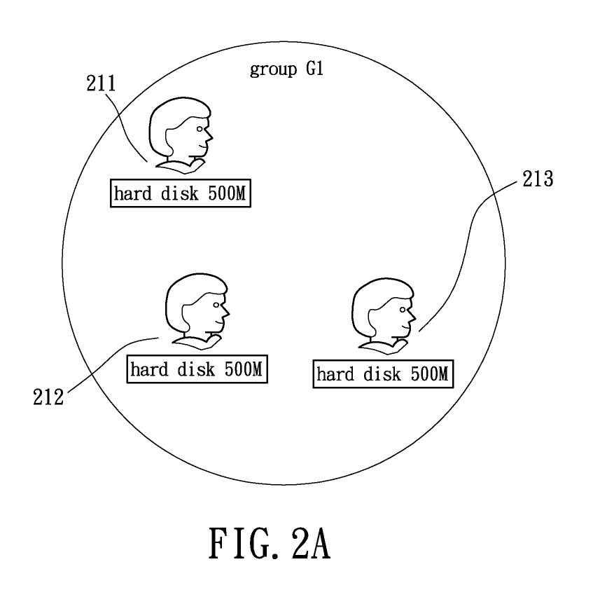

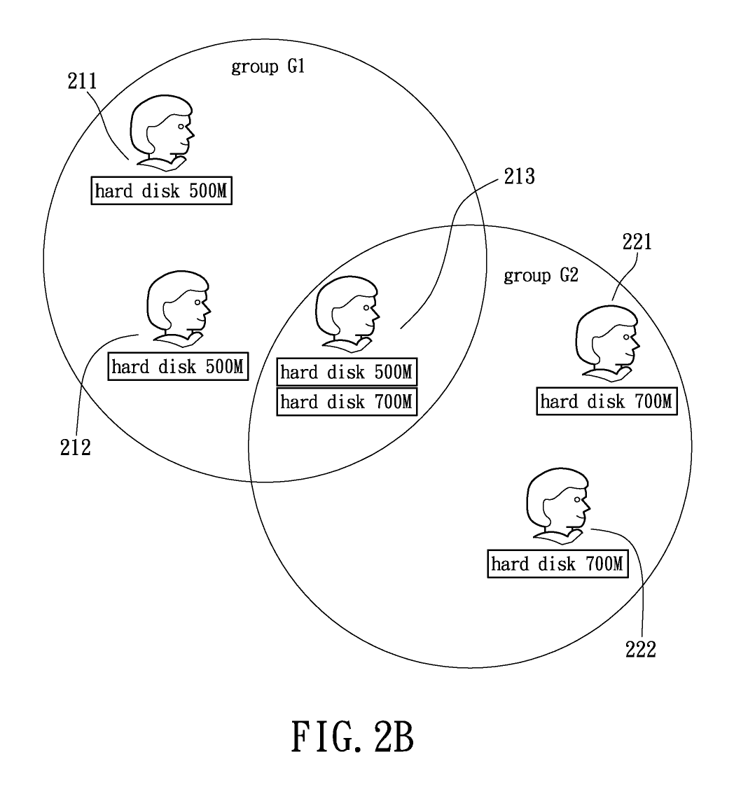

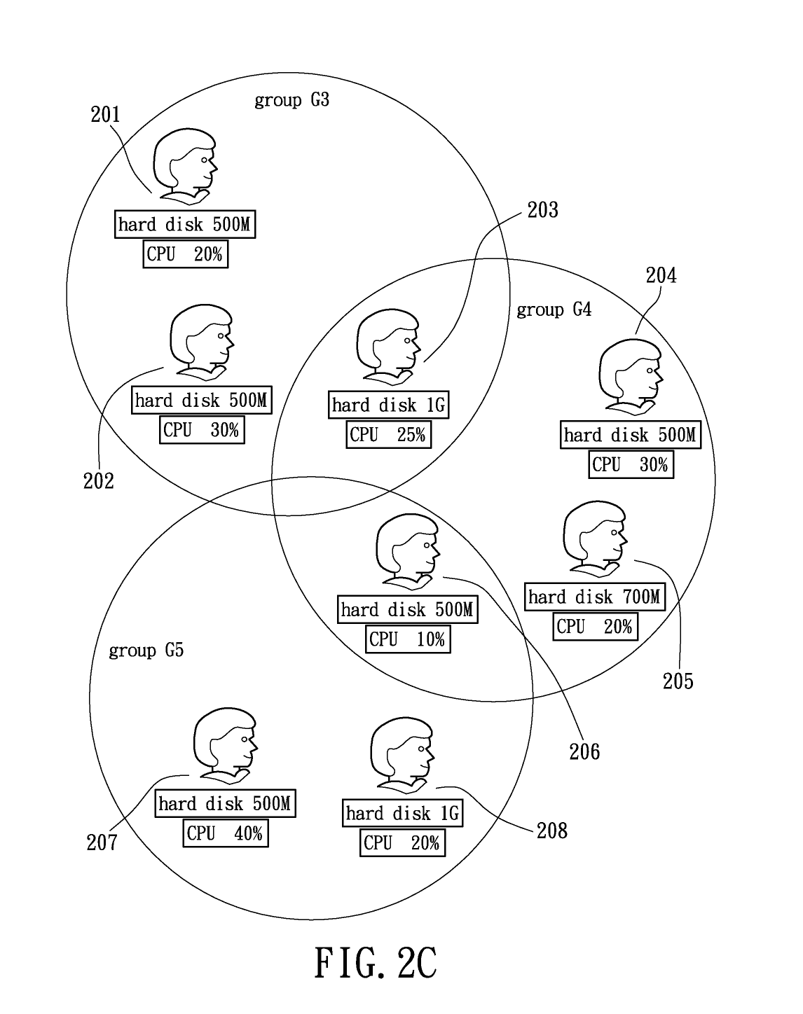

The relation between the group and the group members may be referred to the diagram in FIG. 2A schematically showing the resources shared among the community users.

The example shows a group G1 which includes members 211, 212, and 213. When the user joins this group G1, including the potential members, the user may setup a fixed storage space through a configuration interface. For example, the each shown user contributes an equal space, such as 500 MB. That is, the shared space 500 MB from each computer system forms a storage node which can be united to the other shared spaces from other nodes.

Furthermore, the group G1 administrator may give order that the every group member shall contribute an equal storage space for the group. Any object-to-be-stored may then be stored into the distributed storage space with multiple divided block files according to the storage condition within group G1. In one exemplary example, an availability for the storage for the group may be acknowledged based on the number of group members. The each block file may be distributed to one of the storage nodes according to this availability. The availability for object-to-be-stored may also be enhanced. The scheme of offsite backup is stably implemented.

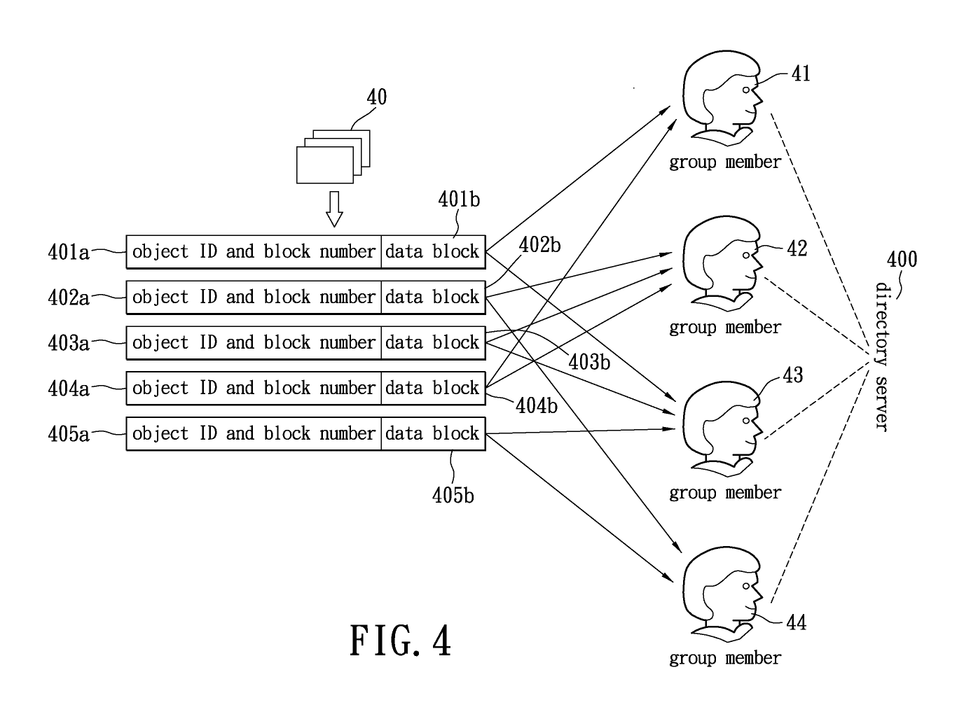

For example, since every member in group G1 provides the same storage space 500 MB, the storage availability is acquired. If the availability is set as 1 to 2 (1:2), the each group member who contributes 500 MB may only gain 250 MB as his redundant space from the total shared spaces. However, the object-to-be-stored may gain double availability. Reference is made to FIG. 4, the shown divided object blocks are stored into two storage spaces, and it has 200% data availability.

### Second Embodiment

FIG. 2B describes a group G1 with the members who may also be the other group's members. As shown in the diagram, a user 213 within the group G1 is also within the group G2. The users 213, 221, 222 are the members of group G2.

Thus the user may join one or more groups. It is noted that the group shall configure every member to be equal condition. The group should provide a stable environment (availability) for members to store their files in case the low availability causes unstable redundancy and risk. In the current example, the every member such as users 211 or 212 joining the group G1 needs to share 500 MB storage space for others.

However, if the other group G2 requires its member to provide 700 MB for the share space, the shown users 221 and 222 need to individually share 700 MB space for the group members. Since the user 213 belongs to both the group G1 and group G2, the user 213 needs to provide 1200 MB (500 MB+700 MB) storage space totally. In an exemplary example, the community server program for running the community activities may setup two independent logical spaces. If one user belongs to multiple groups in practice, the user-end system may correspond to multiple logical storage spaces or tangible storage spaces.

It is worth noting that, if one group owns multiple users, for example N, the maximum availability for data is 1:N. In other words, one file may be stored into the volumes shared by N or less users; if the ratio N for availability is too small, the availability and security for entire data may not be good. On the contrary, if the ratio N is large, the data in the shared volume may not be stable and result in problems because any member quitting the group or even joining the group may make the availability fluctuate. A specific server may be designated to handle the fluctuation of availability in some cases. Thus the ratio N should be adjusted based on actual need.

According to one exemplary example, in a group with n people, if n is larger than 5, the availability for this group may be set up to 5 in order to avoid too much waste. Also, maximum ratio is configured to save the bandwidth while the entire shared space is under adjustment.

### Third Embodiment

FIG. 2C shows one further embodiment in accordance with the invention. The storage space made by the users within the group can be configured by their decisions. The shown groups are group G3, group G4, and group G5. Users 201, 202, and 203 are members of group G3. Users 203, 204, 205, and 206 are members of group G4. Users 206, 207, and 208 are members of group G5. It is shown that some users, such as 203 and 206, are simultaneously belonging to some different groups.

The user-end computer system generally includes a central processor (CPU), one or more hard disks, and the storage of other non-volatile memory. In the sharing system of the network storage and computing resource, the members may selectively share the available-to-shared storage space. For example, the system may provide a configuration interface for configuring the sharing matters. Further, the central processor in each computer system may stay at an idle state, and be able to share part of the computing resource for other group members to perform distributed computation.

The user may configure the available-to-shared computer resource through a configuration interface. In the present example, the user 201 provides 500M hard disk space and 20% computing resource of central processor to be shared; the user 202 shares 500M hard disk space and 30% computing resource; and the user 203 provides 1G hard disk space and 25% computing resource to be shared. It is noted that the user 203 simultaneously shares the resources to the members in both groups G3 and G4. The example shown in the diagram also describes other users' sharing matters.

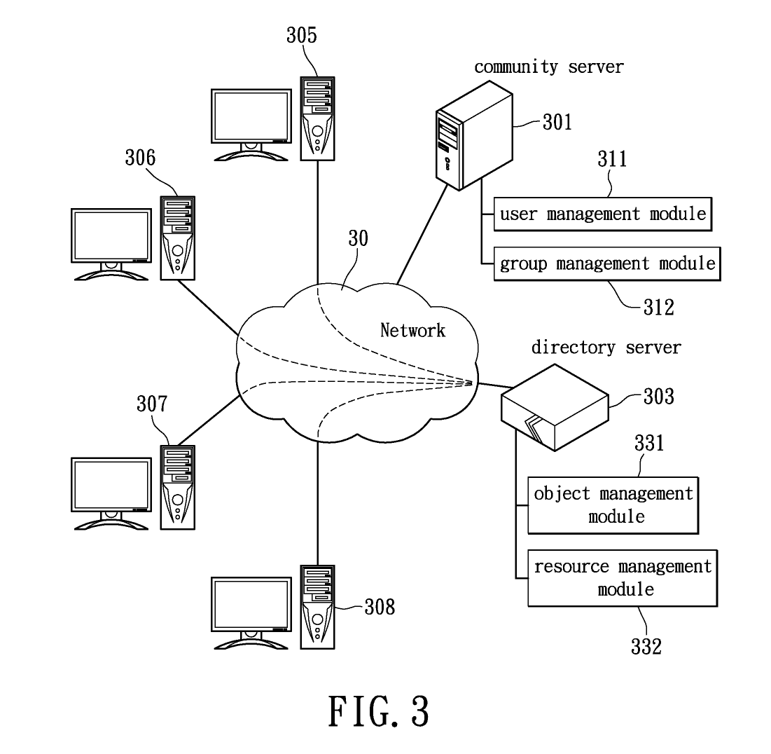

The related system is referred to FIG. 3, which shows a schematic diagram of the system for sharing the network storage and computing resource.

A network framework is shown in the diagram. A community server 301 is provided for serving a community service, especially to build a virtual network community. The server 301, which is implemented by a cluster, a grid computing technology, or workstation, is configured to manage the plurality of users' data and the group activities. In one embodiment, the community server 301 includes a user management module 311, and a group management module 312 depending on its provided functionalities. The related functions may also be executed by software means, such as the management of user data, account, and identification. A community server program installed in the server 301 is used to process the activities of community.

A directory server 303 is also included in the community. This server 303 is charge of backing up or distributed storing the object within the virtual network community. A resource allocation table is particularly introduced to recording the information of the plurality of user-end systems. The table may record the states of the resource distributed over the community, and the computing resource allocation of each end. The directory server 303 exemplarily includes an object management module 331 and a resource management module 332 depending on its functionalities. The object management module 331 and the resource management module 332 are served to manage the object storage among the user ends. A distributed storing process is particularly introduced to storing the object into multiple shared nodes. The storage space and computing resource of processor shared by the nodes (the computers) are also managed by the modules within the directory server 303.

Moreover, the directory server 303 may be a storage node joining the distributed storing process. The directory server 303 may alternatively be a server for completely backing up the object-to-be-stored. In one further embodiment, the directory server is equipped with a throughput counter for operating statistics of the objects and data throughput over the network.

Through the network, including WAN and LAN, the user-end systems 305, 306, 307, and 308 connect with the community server 301 and the directory server 303. The user-end system may be the various types of computer systems. The users may be the members of the community, and join to one or more groups. The every user-end system (such as 305, 306, 307, or 308) can be one of the distributed storage nodes for storing objects.

In particular, one or more virtual (or computer-generated) groups with specified or common characteristics are existed within a community. The users in one group may also belong to other one or more groups. A link establishing a correlation is among the users in one group. The mentioned community server 301 records this correlation by its group management module 312. The group management module 312 is a server module preferably made by a software means. When the user logs in the community server 301, the group management module 312 provides his correlated group(s) based on this link. Through this link, the user receives the various messages relating to the group(s).

In practice, the user-end systems 305, 306, 307, and 308 may anytime synchronize information with the directory server 303. The synchronization is generally related to the available storage node(s), and computing resource(s). It is noting that the community server 301 and the directory server 303 may not be two independent servers, but also to be one server or a cluster, including made by two functional modules within one host. The functional modules for the network community may divisionally process the user accounts, the group relationship, and the managements of object-to-be-stored and computing resource.

The users within one group may define their resource sharing relationship with others according a configuration. For example, the users in this sharing relationship are allowed to share the computing resource, storage, and bandwidth within the group. Under this sharing framework, the various objects may be processed based on a selection in accordance with a sharing list or range for the purpose of security and convenience.

In an instance, the storing scheme may allow the group members to back up their data by one or up to five copies based on a security rating for each member. The security rating may specify a node or directory server 400 for storing the object. Therefore, the security rating ensures the data availability, transmitting rate and security. If any data is announced to be synchronized, such as any user's writing or reading, the client program such as the community server program may notice the users within the list not to shut down the computer system for guaranteeing the data availability. If a user has low availability for a period of time, the most other users may ask him to quit the group.

It is worth noting that, in order to raise up the data availability and rating to writing of the distributed storing scheme, the method for sharing the network storage and computing resource in accordance with the invention may allow some blocks originally distributed to some nodes to be temporarily stored into the directory server or to the node having the highest matching probability. The data may be transferred to the user's system when he gets on the server since the data may be temporarily stored in the directory server or other node.

Furthermore, the redundant space for the object may be specified according to a ratio related to space and the group members. For example, since the ratio is 1 to X (1:X), the each member can gain 1 MB as his redundant space when he shares X Mbytes to the group he belongs to.

Reference is made to FIG. 4 showing a schematic diagram of the object-to-be-divided.

The diagram shows a storage space with ratio 1:2 within the group. The object 40 is divided into multiple blocks. The shown object 40, which is prepared to be stored, is created by a group member. The system for sharing the network storage and computing resource is provided to perform the distributed storing process upon the object 40. At first, as shown in the figure, the object 40 is divided into multiple block files in accordance with an algorithm. Thus the block files may be delivered to the storage nodes over a network via a packet-type transmission. Every block file distributed to the different nodes has a block number, and the block number is related to an object ID.

The object 40 shown in the diagram is divided into multiple block files, and each block file includes at least two parts. One part of the block file is the object ID and block number for use of recognition of the block file. The other part is a data block. The figure exemplarily shows the object ID, block numbers 401a, 402a, 403a, 404a, and 405a, and the data blocks 401b, 402b, 403b, 404b, and 405b.

While the distributed storing process is in progress, the community's directory server 400 may acquire the state of the storage nodes formed by the group members (for example, 41, 42, 43, and 44). The state includes the storage space shared by each node and its location. Next, the block files are configured to be stored in the nodes according to the nodes' states. Furthermore, the object may or may not be encoded before stored into distributed nodes as required.

The conventional encrypting method such as DES (Data Encryption Standard) or RAS may be introduced to encrypting the divided block files. Some other divided encoding methods, such as RAID 5 encryption, for rising up the data availability may also be introduced.

Further, the system shall anytime maintain a certain level of the availability. If the availability is set as 1 to 2 (1:2), the divided block files may be stored into at least two storage nodes for ensuring the object-to-be-stored having 200% data availability.

In addition to the storing scheme described above, the system adapted to the virtual network community provides one further mechanism for sharing the computing resource from each node.

Embodiments to Sharing Computing Resource:

In accordance with one of the embodiments, the community-based group allows part of all the members to share their computing capacities to others based on their agreements. The member requesting a computing request within the group may firstly gain other members' agreements and ask for distributed computation from the system. The system may then deliver the data blocks to the joined computing nodes. After the computation at each node is completed, the computation result is transmitted to a common storage space within the group. The originator may execute a program to collect the results in the storage space, and compile the results into a final result.

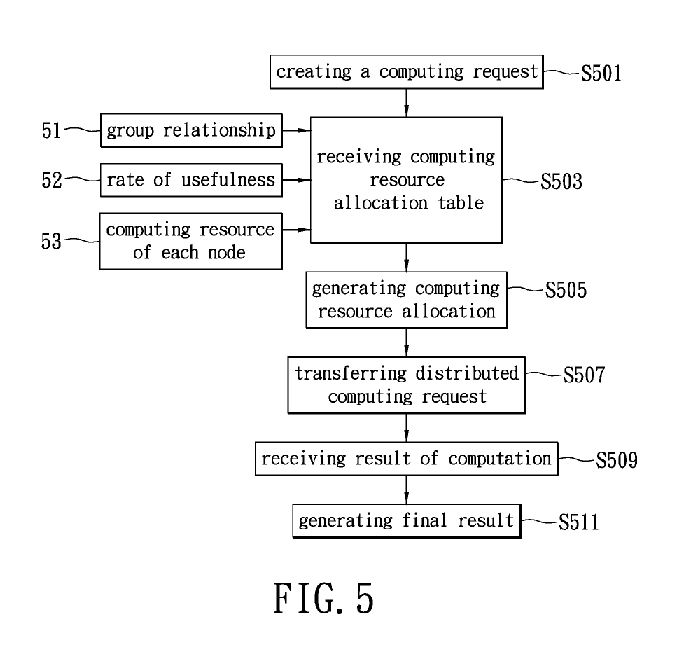

The flow chart shown in FIG. 5 is the process for sharing the computing resource in accordance with the present invention. One of the objectives of the method is to provide a share the idle computing time of the central process of each user-end system. The each user-end system may be installed with a program of distributed computation. An application programming interface (API) will be one of the options for the interfacing program. Not only the program is used to announce a distributed computing request, but also to collect the nodes' computation results and compile the results back to the group's common storage space. Such the image processing or other types of distributed processing may all be involved in this scheme.

In the beginning of the process is such as the step S501, which shows a computing request is generated by a group member using a user-end system. The mentioned program for distributed computation may then issue a message to receive a computing resource allocation table (step S503). For example, a directory server may be used to retrieve the resource allocation table from every node. The distributed computation program then obtain a group relationship 51, a rate of usefulness 52 of each computing resource for further evaluations of the states of every user-end system, network bandwidth, and history record.

The computing resource of each node 53 is referred to generate the configuration of every computing node (step S505). The relevant information is related to a group member list, and rate of usefulness regarding the shared computing resources. The rate of usefulness regards to whether or not the every member is online, his bandwidth, and his history record. The computing resource generally regards to a computer performance of each computing node, and share percentage.

Next, in step S507, the mentioned node's distributed computation program delivers a computing request to the computing nodes. After a period of time to perform the computation, the originator of the request receives the computation result from every computing node through the distributed computation program (step S509). A final result is then compiled from the received results (step S511).

The embodiments related to the shared storage space:

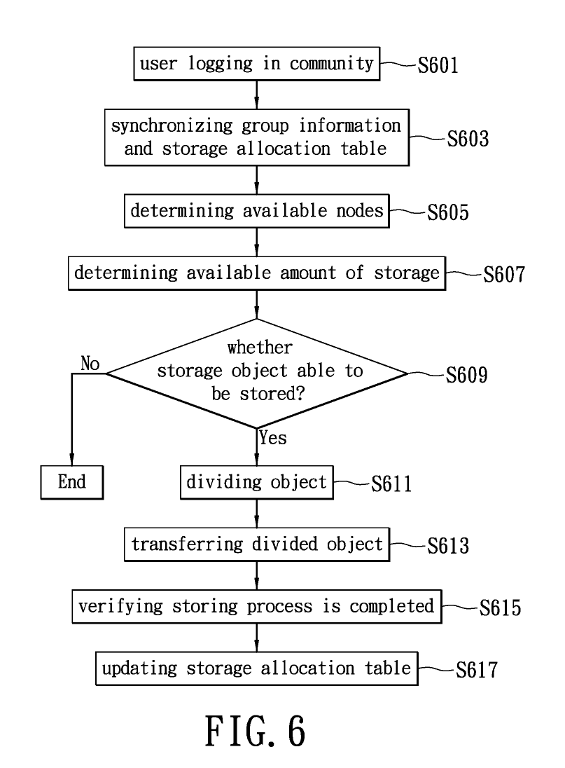

Reference is made to FIG. 6 describing a distributed storing process in accordance with the present invention. In beginning step S601, the user logs in a community server. A web browser may be employed to implementing the login process, especially via the web interface initiated by the community server. Any independent server program executed in the user-end system may also be incorporated. After the login process, in step S603, the user-end system is permitted to link to the community server, and to synchronize with the storage space resource allocation table regarding the group, and the records of multiple storage nodes.

Then the available storage node can be acknowledged according to the storage space resource allocation table (step S605). One or more available storage nodes are accordingly obtained. The object-to-be-stored may be secured by this acknowledgement. The next step is to determine an amount of available storage spaces based on the available storage space of each storage node (step S607). The step S609 integrates the amount of every storage node and determines whether or not the object is able to be stored (step S609).

If the amount is insufficient to store the object, the process is terminated; if the space is sufficient after the determination, a distributed storing process is performed. The process is provided to divide the object-to-be-stored according to a specific distributed algorithm, especially based on the current number of available storage nodes and the shared space. Then the storage object is divided into multiple block files (step S611). After that, the block files are delivered to the specified available storage nodes (step S613). When verifying the storing process is completed (step S615), the storage space resource allocation table is updated (step S617).

During the described storing process, the selection of the one or more storage nodes, shown as the link between the block files and the user-end systems, is exemplarily made according to an average randomness. The selection should avoid too many blocks stored in one storage node. If the distributed users' shared spaces are uneven, for instance overly gathering in few nodes, the system may actively refer to those users' resource availabilities, and perform the storing process accordingly. The various reasons dominating the distribution of the resources include the online time, network bandwidth, and the space size.

Besides the general publishable data, the distributed storing process may be incorporated into storing the user's private data. The group member may indicate the object in the storage space as shareable to other members. The shared object is configured to be public to others. The shared object may not necessary to be encoded and also the related storage space resource allocation table is public and readable to all the group members. The divided blocks shown in the FIG. 4 are indexed with block numbers. Further, the user having one of the shared storage spaces may not see any meaningful data since the encrypting key for the blocks are not existed at the other user ends. In the meantime, the each user end merely acknowledges the ratio of the storage space to be shared. Furthermore, if the data stored in the shared space is marked as public, all the related group members can access the same encrypting key and the allocation table for each block. Therefore, the each group member can rapidly access the object since the space forms a public distributed file system.

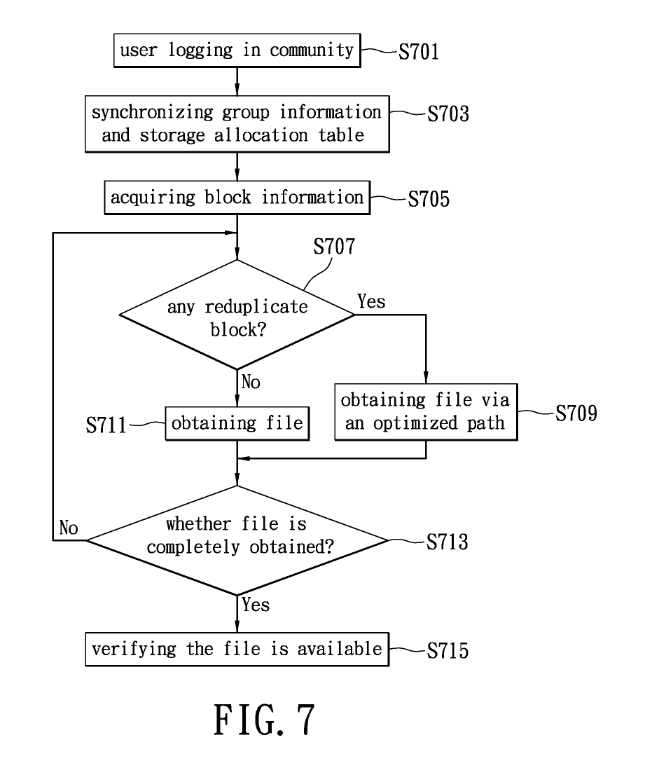

Next, when the user needs to retrieve the file from the distributed file system (from each storage node), FIG. 7 is referred to describe the process for retrieving the file from the nodes.

The user may also logs in the community server (step S701), the community server program, including the independent software installed in the user-end system and initiated through web browser, synchronizes the group information and the storage space resource allocation table with the community server (step S703). The object information is also obtained from the storage space resource allocation table (S705). The table records the allocation of the object in each storage node.

Next, in step S707, the community server program determines whether if there is any reduplicate block. If there is no any reduplicate block, the file can be retrieved directly (step S711); if any reduplicate block is existed, the system may select one preferred route to retrieve the file (step S709). In the current case, the system will firstly acquire the codes corresponding to the blocks from the nodes based on the block allocation in accordance with the storage space resource allocation table. The system may be provided with querying the route to the source group of the each object block. If any identical block is existed, the system may direct the user having higher priority to retrieve the data. The user having higher priority may be registered in a closer network, or has higher linking speed record.

At last, such as step S713, the community server program determines if the file is retrieved completely. If the file is not yet completely retrieved, the process goes on, and repeats the mentioned step S707 and the related steps; if the file is completely retrieved, the file shall be verified (step S715).

Since the group member in the community may vary, any variation may affect the usefulness of the file under distributed storage. It is noted that the system may perform a backup process for the object as the distributed storing process in the group is in progress. The backup process may be performed on a directory server which prepares a backup during the distributed storing process. The backup process may allow the each storage node to back up times of the file. Some other redundancy mechanisms may be incorporated into this scheme. For example, the Redundant Array of Independent Disks (RAID) technology may also be introduced. Therefore, the claimed system provides some backup and redundancy mechanisms to the distributed storing scheme to prevent any possible error or damage made by the variation in the group. For example, the error at the node, or any member's leaving may cause the failure.

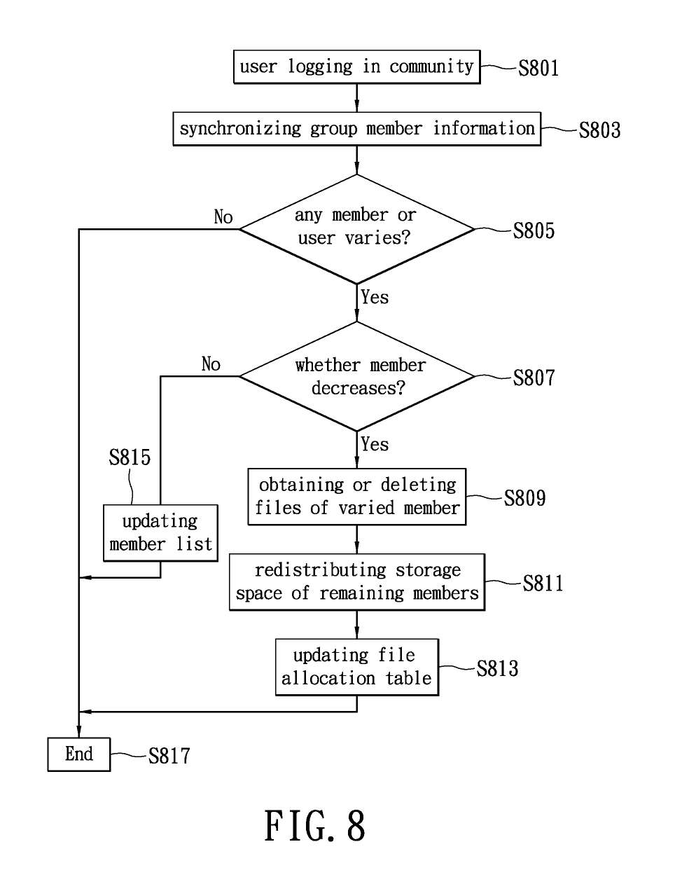

FIG. 8 is a flow chart of processing a situation of the group members being varied according to the present invention.

Step S801 shows a user logging in the community. Immediately, the server synchronizes the information related to the group members (step S803). The information, such as any member's leaving or variation of any node, is included. Next, in step S805, the system determines whether or not any variation to the members, including determining if any change of the computer system at the node causes the failure to the distributed storing process.

If it is determined that no any change to the members (no), the process is terminated (step S817); if any change to the members is found (yes), such as step S807, the community server program further determines if the number of members decreases. If the number does not decrease that means there is new member added. However, there is no any information related to the node of this new added member. The system may immediately update the member list in step S815.

Otherwise, if any member quits the community, or is cancelled (yes), the system performs the step S809 for retrieving back the file or cancels the block file if his is still online. Alternatively, any other backup process may also be used to recover the file, and redistribute the file to other member's storage space (step S811). After that, the system will update the resource allocation table regarding the object information of the group members (step S813). Finally, the present process is terminated (step S817).

To sum up the above description, disclosed is a system for sharing network storage and computing resource adapted to a network community, and a method for implementing the system. A distributed storing and computing technology is introduced. Therefore, the each user end's system resource can be fully used and provided for the virtual network community to share the objects with each other.

It is intended that the specification and depicted embodiment be considered exemplary only, with a true scope and spirit of the invention being indicated by the broad meaning of the following claims.

What is claimed is:

1. A storing method over a network adapted to a virtual network community including a plurality of registered users, comprising:
a user-end system linking to a community server, in which a user logins the virtual network community through the user-end system, and the plurality of user-end systems constitute a plurality of storage nodes;
synchronizing information of the user's group, and recording a resource allocation table for the storage nodes
acknowledging a plurality of available storage nodes from the resource allocation table;
according to amount of available storage spaces of the available storage nodes, determining whether or not an object-to-be-stored is able to be stored;
terminating the steps of the storing method if the amount for storing is not sufficient; and
executing a distributed storing process if the amount for storing is sufficient.

2. The method of claim 1, wherein the distributed storing process comprises:
dividing the object-to-be-stored into a plurality of block files according to the acknowledged available storage nodes and the storage spaces;
transferring the divided block files to each of the available storage node; and
updating the resource allocation table of the storage spaces for the storage nodes after verifying the storing process is completed.

3. The method of claim 2, wherein the plurality of block files are stored into the available storage nodes according to an average randomness.

4. The method of claim 3, wherein each of the block files is transferred to the storage nodes via a via a packet-type transmission, and the each block file distributed over the different storage nodes has a block number that linked with an object ID.

5. The method of claim 2, wherein, when the plurality of block files are stored into the storage nodes by referring to a resource availability of each storage node.

6. The method of claim 5, wherein each block file is transferred to the each storage node via a packet-type transmission, and each block file distributed over the storage nodes has a block number, and links to an object ID.

7. The method of claim 2, wherein the block files stored in the storage nodes are encoded.

8. The method of claim 2, wherein the user's group is configured to have an availability based on a number of users, the each block file is transferred to the plurality of available storage nodes according to the availability.

9. The method of claim 1, wherein the storage spaces allocated to the user-end systems of the user's group are the same.

10. The method of claim 9, wherein each user belongs to multiple groups, and the user-end system has multiple logical storage spaces.

11. A method for sharing computing resource, adapted to a virtual network community including a plurality of registered users, comprising:
a user-end system generating a computing request;
receiving a resource allocation table, and acknowledging a group having the user-end system, rate of usefulness and computing resource of each computing node;
creating configuration for allocating computing resource for each of the computing nodes;
transferring distributed computing request to each computing node; and
the user-end system receiving result of computation from each computing node while the computation at each computing node is completed; and
compiling the result from each computing node and generating a final result.

12. The method of claim 11, wherein the computing resource includes a computer performance and a share percentage for each computing node.

13. The method of claim 11, wherein the rate of usefulness of each computing node includes evaluations of whether or not the user-end system is linked to network, bandwidth, and history record.

14. A system for sharing network storage and computing resource applying the method as claim 1, comprising:
a plurality of user-end systems, linked with a network, wherein users of the user-end systems are members of a virtual network community, and each user belongs to one or more groups;
a community server, linked with the network, being a server of the virtual network community and for managing data and groups of the plurality of users; and
a directory server, linked with the network, for backing up or distributed storing an object in the virtual network community, and recording a resource allocation table for the plurality of user-end systems.

15. The system of claim 14, wherein, a correlation is existed among the users in the virtual network community and thereby establishing a group, the plurality of user-end systems in the group are the distributed storage nodes for the object.

16. The system of claim 14, wherein the community server at least includes a user management module and a group management module.

17. The system of claim 14, wherein the directory server at least includes an object management module and a resource management module.

18. The system of claim 17, wherein the directory server is a redundant space for the object.

19. A system for sharing network storage and computing resource applying the method as claim 11, comprising:
a plurality of user-end systems, linked with a network, wherein users of the plurality of user-end systems are members of a virtual network community, and each user belongs to one or more groups;
a community server, linked with the network, being a server for the virtual network community, and for managing data and groups of the plurality of users; and
a directory server, linked with the network, for backing up or distributed storing an object in the virtual network community, and recording a resource allocation table for the plurality of user-end systems.

20. The system of claim 19, wherein, a correlation is existed among the users in the virtual network community, and thereby establishing a group, and the user-end systems are the storage nodes for the object.
